(19) United States
(12) Patent Application Publication
(10) Pub. No.: US 2021/0125610 A1
(43) Pub. Date: Apr. 29, 2021

(54) AI-DRIVEN PERSONAL ASSISTANT WITH ADAPTIVE RESPONSE GENERATION

(71) Applicant: Facebook Technologies, LLC, Menlo Park, CA (US)

(72) Inventors: Vincent Charles Cheung, San Carlos, CA (US); Tali Zvi, San Carlos, CA (US); Hyunbin Park, Palo Alto, CA (US)

(21) Appl. No.: 16/667,596

(22) Filed: Oct. 29, 2019

(51) Int. Cl. G10L 15/22; G10L 25/63; G10L 25/90; G06F 16/9535; G06F 9/451; G06N 3/00; G06N 20/00; G06N 5/04

(52) U.S. Cl. CPC G10L 15/22; G10L 25/63; G10L 25/90; G06F 16/9535; G10L 2015/228; G06N 3/004; G06N 20/00; G06N 5/04; G10L 2015/223; G06F 9/453

(57) ABSTRACT

A personal assistant system and method. A personal assistant electronic device receives input data indicative of a query specifying a request from a user within an environment. A context processing engine establishes a context for the query, the engine applying trained models to the input data to identify personal and environmental cues associated with the query. A response generator generates a response message based on the request, the query context and a response profile for the user, the response profile specifying one or more preferences for the user, each of the one or more preferences being associated with a manner in which the response generator responds to requests from the user, each of the one or more preferences being set by the response generator in response to feedback from the user to previous response messages.

### TECHNICAL FIELD

This disclosure generally relates to computing systems, and more particularly, to virtual personal assistant systems.

### BACKGROUND

Virtual personal assistants perform tasks or services for users based on commands or queries. Virtual personal assistants are used, for example, to obtain information in response to verbal queries, to control home automation based on user commands and to manage an individual's calendar, to-do lists and email. Virtual personal assistants may be implemented in smartphones and smart speakers, for instance, with an emphasis on voice-based user interfaces.

### SUMMARY

In general, this disclosure describes virtual personal assistant systems that recognize audio commands and that respond to the audio commands with personalized responses. In one example, a virtual personal assistant system determines a context for a spoken query from a user and provides a personalized response to the user based on the context. In one example approach, the virtual personal assistant system determines the context of the query (the “query context”) by applying trained models to the input data to identify personal and environmental cues associated with the query and by then crafting a personalized response to the user based on the query context and on a response profile for the user. The virtual personal assistant system may include a personal assistant electronic device, such as a smartphone or smart speaker, that receives the query specifying a request from a user.

More specifically, this disclosure describes a virtual personal assistant system, driven by artificial intelligence (AI) that applies one or more AI models to generate responses based on an established context for the user. For example, the system may adapt the content of the response to parameters describing the delivery of the query, such as the length, tone, speech pattern, volume, voice, or pace of the spoken query. For example, by applying one or more AI models to the query issued by the user, the system may determine that the user is in a hurry, in a certain mood, outside, inside, surrounded by a crowd, alone, etc. In some examples, based on captured audio and/or video, the system may determine the user is with specific individuals, e.g., a partner, friend, or boss, and adapt the response as such. As additional examples, the system may determine future events scheduled on the user's calendar and modify the content of a response to a given query based on future scheduled events. The system may access the user's social media to obtain personal cues in addition to those identified through analysis of the query.

In one example, the virtual personal assistant includes a personal assistant electronic device that receives input data indicative of a query specifying a request from a user within an environment; a context processing engine configured to establish a context for the query, the engine applying trained models to the input data to identify personal and environmental cues associated with the query; and a response generator configured to output a response message based on the request, the query context and a response profile for the user, the response profile specifying one or more preferences for the user, each of the one or more preferences being associated with a manner in which the response generator responds to requests from the user, each of the one or more preferences being set by the response generator in response to feedback from the user to previous response messages.

In another example, a method includes receiving, by a personal assistant electronic device, input data indicative of a query specifying a request from a user within an environment; determining, on a processor, a context for the query, wherein determining includes applying trained models to the input data to identify personal and environmental cues associated with the query; and transmitting a response message to the user based on the request, the response message constructed based on the query context and on a response profile for the user, the response profile specifying one or more preferences for the user, each of the one or more preferences being associated with a manner in which the response generator responds to requests from the user, each of the one or more preferences being set by the response generator in response to feedback from the user to previous response messages.

In yet another example, a computer-readable storage medium comprising instructions that, when executed, configure one or more processors to receive input data indicative of a query specifying a request from a user within an environment; determine, on a processor, a context for the query, wherein determining includes applying trained models to the input data to identify personal and environmental cues associated with the query; and transmit a response message to the user based on the request, the response message constructed based on the query context and on a response profile for the user, the response profile specifying one or more preferences for the user, each of the one or more preferences being associated with a manner in which the response generator responds to requests from the user, each of the one or more preferences being set by the response generator in response to feedback from the user to previous response messages.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is an illustration depicting an example virtual personal assistant system, in accordance with the techniques of the disclosure.

FIG. 2 is a block diagram illustrating another example of a virtual personal assistant system, in accordance with the techniques of the disclosure.

FIG. 3 is a block diagram illustrating another example of a virtual personal assistant system, in accordance with the techniques of the disclosure.

FIG. 4 is a flowchart illustrating example operation of virtual personal assistant system 10 of FIGS. 1-3, in accordance with the techniques of the disclosure.

FIG. 5 is an illustration depicting another example virtual personal assistant system, in accordance with the techniques of the disclosure.

FIG. 6 is a flowchart illustrating example operation of virtual personal assistant system of FIGS. 1-3 and 5, in accordance with the techniques of the disclosure.

Like reference characters refer to like elements throughout the figures and description.

### DETAILED DESCRIPTION

Virtual personal assistants perform a variety of tasks and services for users based on commands or queries. Virtual personal assistants may be used, for instance, to obtain information in response to verbal queries, or to control home automation. The typical virtual personal assistant, however, responds in the same way to each query, no matter the identity of the user or the user's environment. That is, anytime a user asks a question, the user receives about the same answer.

This disclosure describes a virtual personal assistant that includes a personal assistant electronic device, such as a smartphone or smart speaker, that receives a query specifying a request from a user and that adaptively responds to the user based on an identified context for the user. For example, the system may adapt the content of the response to parameters such as the length, tone, speech pattern, volume, voice, or pace of the query. For example, by applying one or more AI models to the query issued by the user, the virtual personal assistant may determine that the user is in a hurry, in a certain mood, outside, inside, surrounded by a crowd, alone, etc. In some examples, based on captured audio and/or video, the system may determine the user is with specific individuals, e.g., partner, friend, boss, and may adapt the response as such. As additional examples, the system may determine future events scheduled on the user's calendar and modify the content of a response to a given query based on future scheduled events. The system may access the user's social media to obtain personal cues in addition to those identified through analysis of the query. The virtual personal assistant may be used, for example, as a standalone device, as an application executing on a device (e.g., a mobile phone or smart speaker), or as part of an AR/VR system, video conferencing device, or the like.

In one example approach, the virtual personal assistant adapts to the user's preferences. If the user prefers terse replies, the replies are generally terse. User preferences may also extend to other areas, such as, for instance, sentence structure, sentence style, degree of formality, tone and tempo. In some approaches, user preferences are weighed against query context and the personality of the virtual personal assistant when preparing a replying to a query.

In some examples, the virtual personal assistant includes a personal assistant electronic device having at least one input source that receives input data indicative of a query specifying a request from a user within an environment. The virtual personal assistant further includes a context processing engine configured to apply one or more trained models to the input data to determine a context for the query, the query context based on at least one personal cue obtained by applying the one or more trained models to the input data and on any environmental cues obtained by applying the one or more trained models to the input data, and a response generator maintaining a response profile for the user, the response profile specifying data indicative of one or more preferences for the user, each of the one or more preferences being associated with a manner in which the response generator responds to requests from the user, each of the one or more preferences being set by the response generator in response to feedback from the user on responses to previous requests by the user. The response generator is configured to output, based on the request, a response message for the user, where the response generator is configured to construct the response message based on the query context and the response profile for the user.

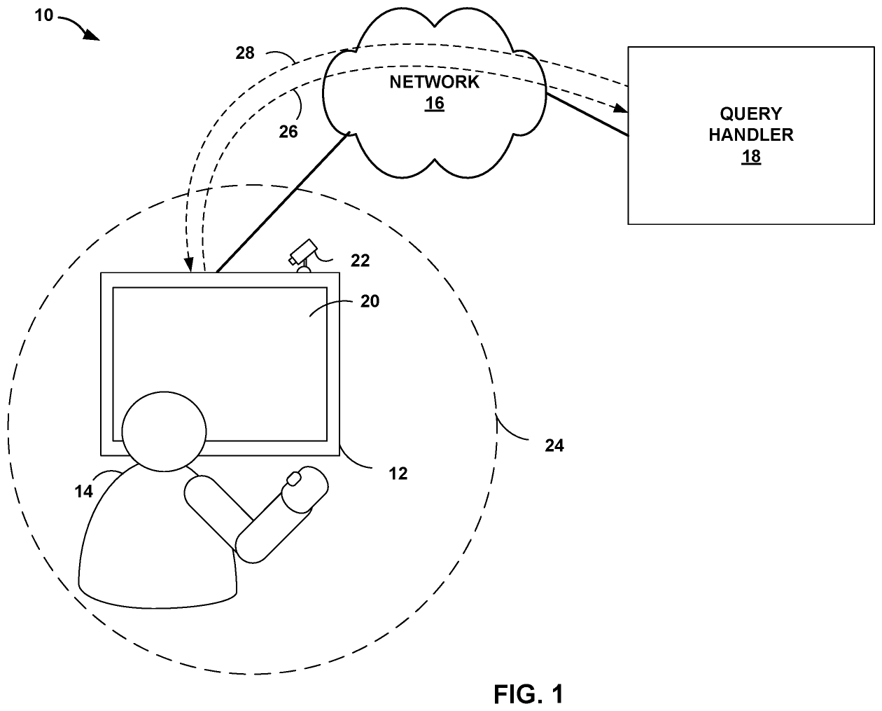

FIG. 1 is an illustration depicting an example virtual personal assistant system 10, in accordance with the techniques of the disclosure. In the example approach of FIG. 1, virtual personal assistant system 10 includes a personal assistant electronic device 12 that responds to queries from a user 14. Personal assistant electronic device 12 of FIG. 1 is shown for purposes of example and may represent any personal assistant electronic device, such as a mobile computing device, smartphone, smart speaker, laptop, tablet, laptop, desktop, artificial reality system, wearable or dedicated conferencing equipment. In the example shown in FIG. 1, personal assistant electronic device 12 includes a display 20 and a multimedia capture system 22 with voice and image capture capabilities. While described as a multimedia capture device, in some examples a microphone only may be used to receive a query from user.

As shown in FIG. 1, personal assistant electronic device 12 is connected to a query handler 18 over a network 16. A user 14 submits a query to personal assistant electronic device 12. Personal assistant electronic device 12 captures the query and forwards a request 26 based on the query to query handler 18 over network 16, such as a private network or the Internet. Query handler 18 prepares a response 28 to the query and forwards the response 28 to personal assistant electronic device 12 over network 16.

In some examples, virtual personal assistant system 10 examines audio characteristics of a spoken query to gain insight into user 14. In some such examples, virtual personal assistant system 10 examines video characteristics of a query to gain further insight into user 14. In some examples, virtual personal assistant system 10 examines an environment 24 surrounding user 14 when constructing personalized responses to queries received from user 14.

Digital personal assistants tend to respond in the same way to each query, no matter the identity of the user or the user's environment. If a user asks, “What is the weather going to be tomorrow morning?” the answer is always a sentence saying, “Tomorrow morning it will be 53 degrees F., partly sunny, with a high of 65.” No matter how the question is asked, the answer is always the same.

In one example approach, virtual personal assistant system 10 uses information about user 14 and environment 24 obtained from the query to provide tailored responses to user queries. For instance, virtual personal assistant system 10 may modify responses based on contextual and auditory clues. The changes may be made in the content delivered, the manner of delivery, or both. In some example approaches, the answers also change to reflect personal preferences on the part of user 14. In some such example approaches, the answers also change to reflect a personality associated with virtual personal assistant system 10.

In some examples, personal assistant electronic device 12 may be configured to perform facial recognition and to respond to queries in a personalized manner upon detecting a facial image of a known, pre-defined user. In some such examples, upon detecting a facial image of a known, pre-defined user, personal assistant electronic device 12 may be configured to obtain user preferences for personalized responses to queries. In some such examples, one or more users, such as user 14, may configure virtual personal assistant system 10 by capturing respective self-calibration images (e.g., via multimedia capture system 22).

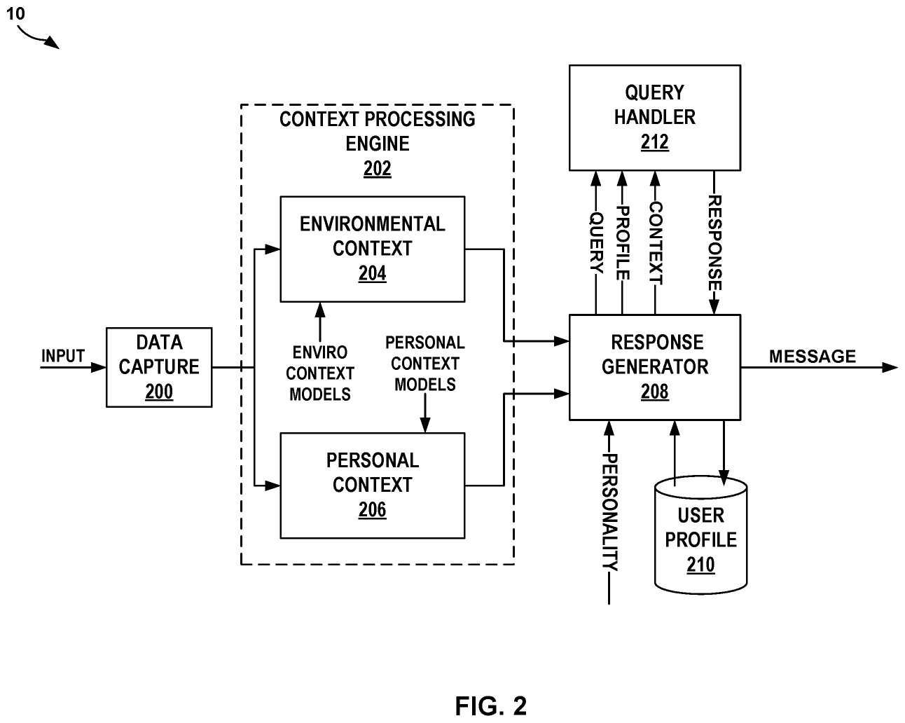

FIG. 2 is a block diagram illustrating another example of a virtual personal assistant system, in accordance with the techniques of the disclosure. In the example of FIG. 2, virtual personal assistant system 10 includes a data capture system 200, a context processing engine 202, a response generator 208 and a query handler 212. Data capture system 200 captures a query from user 14, captures the context of the query and forwards the query and context to context processing engine 202. For instance, data capture system 200 may, in one example, include a microphone used to capture audio signals related to the query and an ability to determine the identity of user 14. In such an example, data capture system 200 may capture a query from user 14, may capture the audio and the user identity as part of the context of the query and may forward the query, the audio, the user identity and other context to context processing engine 202. In one example approach, data capture system 200 is the personal assistant electronic device 12 shown in FIG. 1.

Context processing engine 202 receives the query and context information from data capture system 200 and extracts additional context information from the query before passing the query the received context information and the extracted context information to response generator 208. In one example, response generator 208 receives the query and the context information detailing the context of the query from context processing engine 202, forwards the query to query handler 212, receives a response back from query handler 212 and generates a message for user 14 based on the context of the query. In one such example approach, response generator 208 receives the query and the context of the query from context processing engine 202, forwards the query to query handler 212, receives a response back from query handler 212 and generates a message for user 14 based on the context of the query and characteristics (such as emotion) of a personality assigned to the personal assistant of virtual personal assistant system 10. In some example approaches, a virtual personal assistant system 10 may be configured to be comforting, or professional, or taciturn, and response generator 208 constructs a response based on the response from query handler 212, the context of the query and one or more personality characteristics selected for virtual personal assistant system 10.

In one example approach, response generator 208 generates the message for user 14 using a natural language generator, conditioned on one or more of the personality of virtual personal assistant system 10, environmental cues and personal cues such as the tone of the query and the tempo of the query. In one such example approach, response generator 208 generates text-to-speech to provide a desired tone or tempo, conditioned on one or more of the emotional characteristics of the personal assistant, the tone of the query and the tempo of the query.

In one example approach, context is divided into two categories: environmental context (where are you, what's going on around you) and personal context (in what is tone of voice are you speaking, what words are you using, how quickly are you speaking, how are you feeling (i.e., what are your emotions))). If a user 14 is at home, it is late at night and the user's query indicates he or she is relaxed, system 10 may speak more gently instead of responding in a normal tone. On the contrary, if system 10 detects road noises, that may mean that the user is outside and system 10 will respond accordingly. In one such example approach, context processing engine 202 includes an environmental context system 204 and a personal context system 206, as shown in FIG. 2. In some examples, each context system 204, 206 uses artificial intelligence to develop models for determining the relevant context.

In one example approach, the virtual personal assistant adapts to the user's preferences. If the user prefers terse replies, the replies are generally terse. User preferences may also extend to other areas, such as, for instance, sentence structure, sentence style, degree of formality, tone and tempo. In some example approaches, user preferences are made in response to the answer to a query. For instance, if the response to “What is the temperature?” is “48 degrees Fahrenheit,” user 14 may respond “I prefer Centigrade.” The change would be noted in the profile of user 14 and future responses would be in Centigrade. In other examples, user preferences are made via a use interface, such as a menu of user preferences. For instance, in the example above, user 14 may open a menu to change a preference from “Fahrenheit” to “Centigrade” after receiving the response “48 degrees Fahrenheit.” In some approaches, user preferences are weighed against query context and the personality of the virtual personal assistant when preparing a replying to a query. For instance, a user's preference for more detailed responses may be weighed against a query context that shows the user is in a hurry and a personal assistant personality that tends to more conversational responses to determine the content and tempo of the response to the query.

In some examples, response generator 208 maintains a user profile store 210 containing information on how to modify a response to a query as a function of a user identity. For instance, if a user is known to expect temperature in Fahrenheit, a response to “What is the temperature outside?” might be “84 degrees” instead of “84 degrees Fahrenheit.” Similarly, if a user 14 indicated a preference for terse answers, for flowery answers, or for answers in a given dialect, such preferences would be stored in user profile store 210.

In some examples, response generator 208 maintains a user profile store 210 containing information on how to modify a response to a query as a function of a characteristic of a user. For instance, user profile store 210 may include system preferences for replying to queries from children, or from the elderly.

Query handler 212 receives the query and context information from response generator 208 and replies with a response to the query based on the query and context information. For instance, the context information may indicate that the user would prefer a terse reply, so the response sent to response generator 208 is terse. On the other hand, the context may indicate that the user is interested in all relevant information, and the response may include facts peripheral to the query. For instance, if the query is “Do I need an umbrella today?” and the context indicates that the user is interested in all relevant information, the response from query handler 212 may include the local weather, and the weather at locations the user's calendar indicate he or she will be visiting today, and a determination if there is a likelihood it will be raining in any of those locations at the time the user visits. Response generator takes that response and prepares a message for the user stating, for example, “You will need one because you will be in San Francisco this afternoon for the meeting at 3 PM and it is likely to be raining.”

On the other hand, if the query is “Do I need an umbrella today?” and the context indicates that the user is interested in a terse response, the response from query handler 212 may a determination if there is a likelihood it will be raining in any of those locations at the time the user visit. Response generator may then take that response and prepare a message for the user stating, “Yes.”

In another example, if the query from two or more users is “Do we need an umbrella today?” and the context indicates the identity of the users and that the users are interested in all relevant information, the response from query handler 212 may include the local weather, and the weather at locations the users' calendars indicate they will be visiting today, and a determination if there is a likelihood it will be raining in any of those locations at the time each particular user visits. Response generator 208 takes that response and prepares a message for the users stating, for example, “John, you will need one because you will be in San Francisco this afternoon for the meeting at 3 PM and it is likely to be raining. Sarah, you will not need an umbrella.”

Similarly, if the query from two or more users is “Where do we go next?” and the context indicates the identity of the users and that the users are interested in terse information, the response from query handler 212 may include a name and a location for each user derived from, for instance, the users' calendars. Response generator 208 takes that response and prepares a message for the users stating, for example, “John, Room 102. Sarah, Room 104.”

In some examples, the context information sent to query handler is a subset of the query information received by response generator 208. In some examples, response generator 208 may delete the user identifier information but include profile information retrieved from user profile store 210 in the information sent to query handler 212. Query handler 212 receives the query, the context information and the profile information and replies with a response to the query based on the query, the context information and the profile information.

In one such example approach, response generator 208 generates the response using a natural language generator, conditioned on one or more of the personality of virtual personal assistant system 10, environmental cues and personal cues such as the tone of the query and the tempo of the query. In one such example approach, response generator 208 generates text-to-speech to provide a desired tone or tempo, conditioned on one or more of the emotional characteristics of the personal assistant, the tone of the query and the tempo of the query.

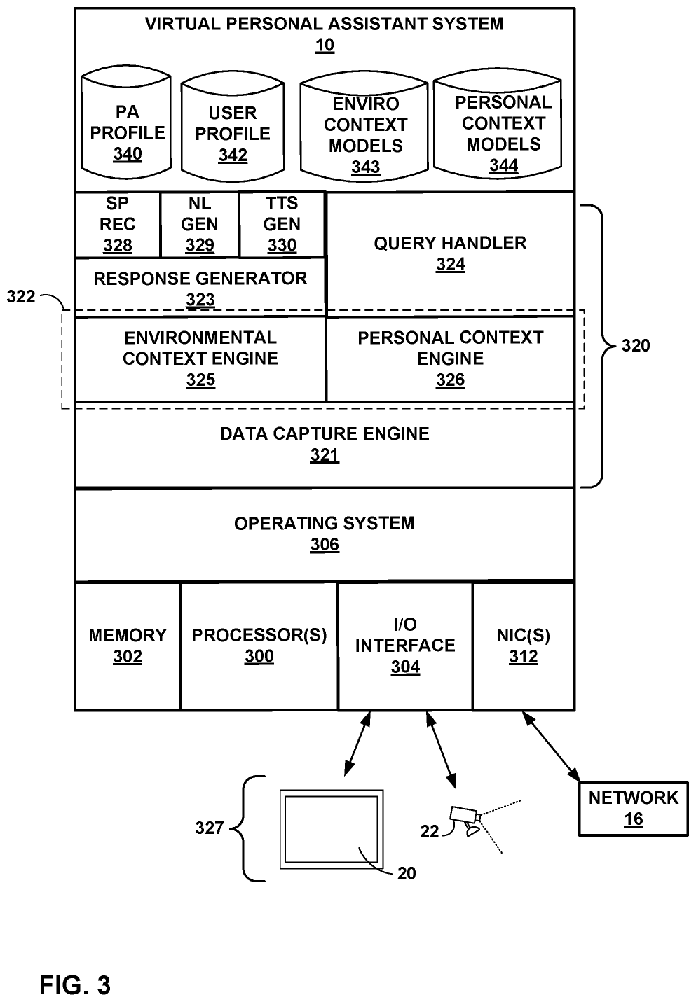

FIG. 3 is a block diagram illustrating an example virtual personal assistant system 10, in accordance with the techniques of the disclosure. For purposes of example, virtual personal assistant system 10 is explained in reference to FIGS. 1 and 2. In the example shown in FIG. 3, virtual personal assistant system 10 includes memory 302 and one or more processors 300 connected to memory 302. In some example approaches, memory 302 and the one or more processors 300 provide a computer platform for executing an operating system 306. In turn, operating system 306 provides a multitasking operating environment for executing one or more software components 320. As shown, processors 300 connect via an I/O interface 304 to external systems and devices 327, such as a display device (e.g., display 20), keyboard, game controllers, multimedia capture devices (e.g., multimedia capture system 22), and the like. Moreover, network interface 312 may include one or more wired or wireless network interface controllers (NICs) for communicating via network 16, which may represent, for instance, a packet-based network.

In the example implementation, software components 320 of virtual personal assistant system 10 include a data capture engine 321, a context processing engine 322, a response generator 323 and a query handler 324. In some example approaches, context processing engine 322 includes an environmental context engine 325 and a personal context engine 326. In some example approaches, software components 320 represent executable software instructions that may take the form of one or more software applications, software packages, software libraries, hardware drivers, and/or Application Program Interfaces (APIs). Moreover, any of software components 320 may display configuration menus on display 20 or other such display for receiving configuration information. Furthermore, any of software components 320 may include, for example, one or more software packages, software libraries, hardware drivers, and/or Application Program Interfaces (APIs) for implementing the respective component 320.

In general, data capture engine 321 includes functionality to receive queries and context for the queries from one or more users 14. For example, data capture engine 321 receives an inbound stream of audio data and video data from multimedia capture system 22, detects a query and forwards the query with any context information it has determined around the query to context processing engine 322. In some examples, data capture engine 321 includes facial recognition software used to identify the source of the query. User identity then becomes part of the context information forwarded to context processing engine 322. In other example approaches, user identity is determined by logging into virtual personal assistant system 10, by accessing virtual personal assistant system 10 via an authenticated device, through voice recognition, via a badge or tag, by shape or clothing, or other such identification techniques. In some example approaches data capture engine 321 is an application executing on personal assistant electronic device 12 of FIG. 1.

In the example of FIG. 3, context processing engine 322 receives the query and context information from data capture engine 321 and extracts additional context information from the query before passing the query, the context information received from data capture engine 321 and the context information captured by context processing engine 322 to response generator 323. In one example, response generator 323 receives the query and the context information detailing the context of the query from context processing engine 322 and generates a response based on the query and the context of the query. In one such example approach, response generator 323 receives the query and the context of the query from context processing engine 322 and generates a response based on the query, the context of the query and characteristics (such as emotion) of a personality assigned to the personal assistant of virtual personal assistant system 10. In one such example, personality characteristics are stored in personal assistant profile 340 as shown in FIG. 3.

As noted above in the discussion of FIG. 2, in one example approach, context is divided into two categories: environmental context (where are you, what's going on around you) and personal context (in what is tone of voice are you speaking, what words are you using, how quickly are you speaking, how are you feeling (i.e., what are your emotions))). In one such example approach, context processing engine 322 includes an environmental context engine 325 and a personal context engine 326 (204 and 206, respectively of FIG. 2). In some examples, each context system 325, 326 uses artificial intelligence to develop models for determining the relevant context. The environmental context identifying models are store in environmental context models 343, while the personal context identifying models are stored in personal context models 344.

In one example, response generator 323 receives the query and the context information detailing the context of the query from context processing engine 322, forwards the query to query handler 324, receives a response back from query handler 324 and generates a message for user 14 based on the context of the query. In one such example approach, response generator 323 receives the query and the context of the query from context processing engine 322, forwards the query to query handler 324, receives a response back from query handler 324 and generates a message for user 14 based on the context of the query and characteristics (such as emotion) of a personality assigned to the personal assistant of virtual personal assistant system 10. In some example approaches, a virtual personal assistant system 10 may be configured to be comforting, or professional, or taciturn, and response generator 323 constructs a response message for user 14 based on the response from query handler 324, the context of the query and one or more personality characteristics selected for virtual personal assistant system 10 and stored in personal assistant profile 340.

In one example approach, response generator 323 includes a speech recognition engine 328 (illustrated as “SP Rec 328”), a natural language generator 329 (illustrated as “NL Gen 329”) and a text-to-speech generator 330 (illustrated as “TTS Gen 330”). In one example approach, speech recognition engine 328 receives the input data captured by data capture engine 321 and determines the query from the input data. In one example approach, response generator 323 generates the message for user 14 using natural language generator 329, conditioned on one or more of the personality of virtual personal assistant system 10, environmental cues and personal cues such as the tone of the query and the tempo of the query. In one such example approach, response generator 323 generates text-to-speech via text-to-speech generator 330 to provide a desired tone or tempo, conditioned on one or more of the emotional characteristics of the personal assistant, the tone of the query and the tempo of the query.

In some examples, response generator 323 also maintains in user profile store 342 information on how to modify a response to a query as a function of a user identity. In some such examples, response generator 323 maintains in user profile store 342 information on how to modify a response to a query as a function of a characteristic of a user. For instance, user profile store 342 may include system preferences for replying to queries from children, or from the elderly, or from people dressed like medical professionals.

Query handler 324 receives the query and context information from response generator 323 and replies with a response to the query based on the query and the context information. For instance, the context information may indicate that the user would prefer a terse reply, so the response sent to response generator 323 is terse. In some example approaches, query handler 324 has the permissions necessary to access calendars and social media. In some such example approaches, query handler accesses one or more of a user's calendar and social media to obtain information on where the user will be in the future and uses that information to inform the response to the query. For example, a user's calendar may show where the user will be for the rest of the day, and that information may be used to obtain weather information for each location in order to predict if the user will encounter rain.

In some examples, query handler 324 receives query, user profile information and context information from response generator 323 and replies with a response to the query based on the query, user profile information and the context information. For instance, even though the context information does not include any indicia that would lead to a terse message, the user profile information may indicate that the user would prefer a terse reply, so the response sent to response generator 323 is terse.

In one example, context processing engine 322 trains the environmental context identification models stored in environmental context models store 343 to recognize environmental cues using context information from previous queries. Context processing engine 322 also trains the personal context identification models stored in personal context models store 344 to recognize personal cues using context information from previous queries. In some example approaches, each environmental context identification model identifies one or more environmental cues and each personal context identification models identifies one or more personal cues. In one example approach, an acoustic event model is used to identify acoustic environments such as inside, outside, noisy, or quiet. Location information may be used to determine if the response to user 14 should be presented quietly (e.g., in a library). In some example approaches, environmental cues include time of day, degree of privacy, detecting the number of people around the user, or detecting the people with user 14. In some such example approaches, facial recognition is used to detect people other than the user.

Personal cues revolve around emotion. A user 14 may speak fast, or loud, or angrily, or softly. The tone or tempo of the query may indicative of stress or short temper. In one example approach, personal cues include user identifiers, user parameters, as well as tone of voice, pitch, cadence, pace, volume, emotion, and other indicia of the spoken delivery of the query by the user.

In some example approaches, virtual personal assistant system 10 is a single device, such as a mobile computing device, smartphone, smart speaker, laptop, tablet, workstation, desktop computer, server, wearable or dedicated conferencing equipment. In other examples, the functions implemented by data capture engine 321 are implemented on the personal assistant electronic device 12 of FIG. 1. In yet other examples, the functions performed by a data capture engine 321, context processing engine 322, response generator 323 and query handler 324, may be distributed across a cloud computing system, a data center, or across a public or private communications network, including, for example, the Internet via broadband, cellular, Wi-Fi, and/or other types of communication protocols used to transmit data between computing systems, servers, and computing devices. In some examples, processors 300 and memory 302 may be separate, discrete components. In other examples, memory 302 may be on-chip memory collocated with processors 300 within a single integrated circuit.

Each of processors 300 may comprise one or more of a multi-core processor, a controller, a digital signal processor (DSP), an application specific integrated circuit (ASIC), a field-programmable gate array (FPGA), or equivalent discrete or integrated logic circuitry. Memory 302 may include any form of memory for storing data and executable software instructions, such as random-access memory (RAM), read only memory (ROM), programmable read only memory (PROM), erasable programmable read only memory (EPROM), electronically erasable programmable read only memory (EEPROM), and flash memory.

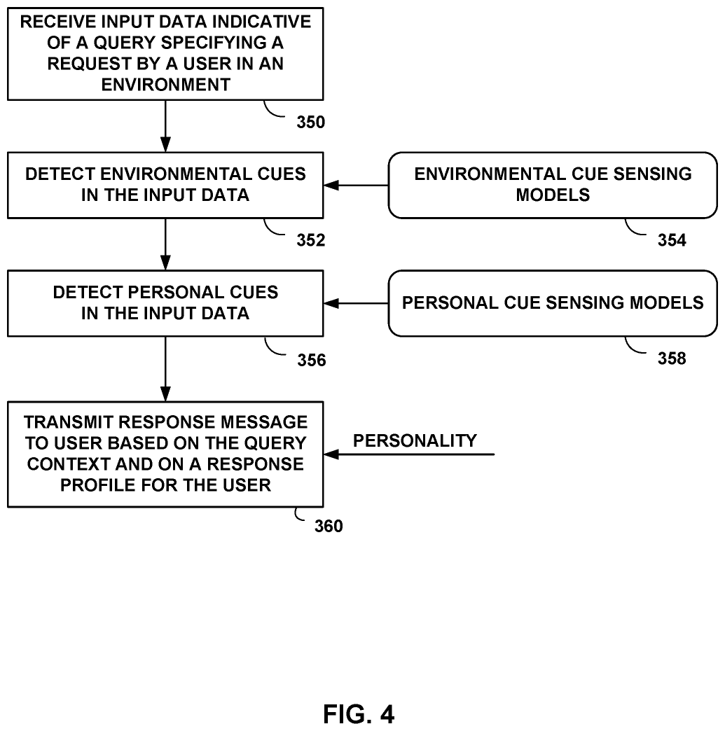

FIG. 4 is a flowchart illustrating example operation of virtual personal assistant system 10 of FIGS. 1-3, in accordance with the techniques of the disclosure. In the example shown in FIG. 4, virtual personal assistant system 10 receives one or more of audio data and image data as input data at data capture engine 321. The input data may comprise one or more of an audio track, a single image or a video stream captured by input capture device 22. If the input data received by data capture engine 321 indicates that the input data includes a query by a user, the input data is forwarded with any available context data to context processing engine 322 (350). In some example approaches, data capture engine 321 applies speech recognition software to the input data to extract the query before sending the query and the input data to context processing engine 322. In other example approaches, data capture engine 321 sends the input data to context processing engine 322 and the query is extracted by speech recognition engine 328 in response generator 323.

Context processing engine 322 receives the input data (with or without query) and any other context information developed by data capture engine 321 (such as user identity) and applies environmental cue sensing models 354 to the context information to detect one or more environmental cues (such as, e.g., quiet environment, noisy environment, time of day, good acoustics, bad acoustics, location (e.g., home, work, or restaurant), indoor environment or outdoor environment) (352). Context processing engine 322 then applies personal cue sensing models 358 to the context information to detect one or more personal cues (such as, e.g., emotion, tone, or tempo) (356).

In one example approach, response generator 323 receives the query and the context information detailing the context of the query (including environmental and personal cues) from context processing engine 322 and generates a message for user 14 based on the context of the query and on a response profile for the user (360). In some example approaches, response generator 323 forwards the query to query handler 324 and receives a response back from query handler 324. Response generator 323 then generates a message for user 14 based on the response and the response profile stored in user profile store 332. In some examples, response generator 323 generates a message for user 14 that matches the tone, tempo or emotion of user 14 when appropriate or that uses a tone, tempo or emotion other than the user's when appropriate.

In another example approach, response generator 323 receives the input data and the other context information detailing the context of the query (including environmental and personal cues) from context processing engine 322, applies speech recognition software to determine the query and generates a message for user 14 based on the context of the query and on a response profile for the user. In some example approaches, response generator 323 forwards the query to query handler 324 and receives a response back from query handler 324. Response generator 323 then generates a message for user 14 based on the response and on the response profile stored in user profile store 332.

In some example approaches, response generator 323 generates a message for user 14 based on the response, on the context of the query and on characteristics (such as emotion) of a personality assigned to the personal assistant of virtual personal assistant system 10. In some example approaches, one or more personality characteristics selected for virtual personal assistant system 10 are stored in personal assistant profile 340.

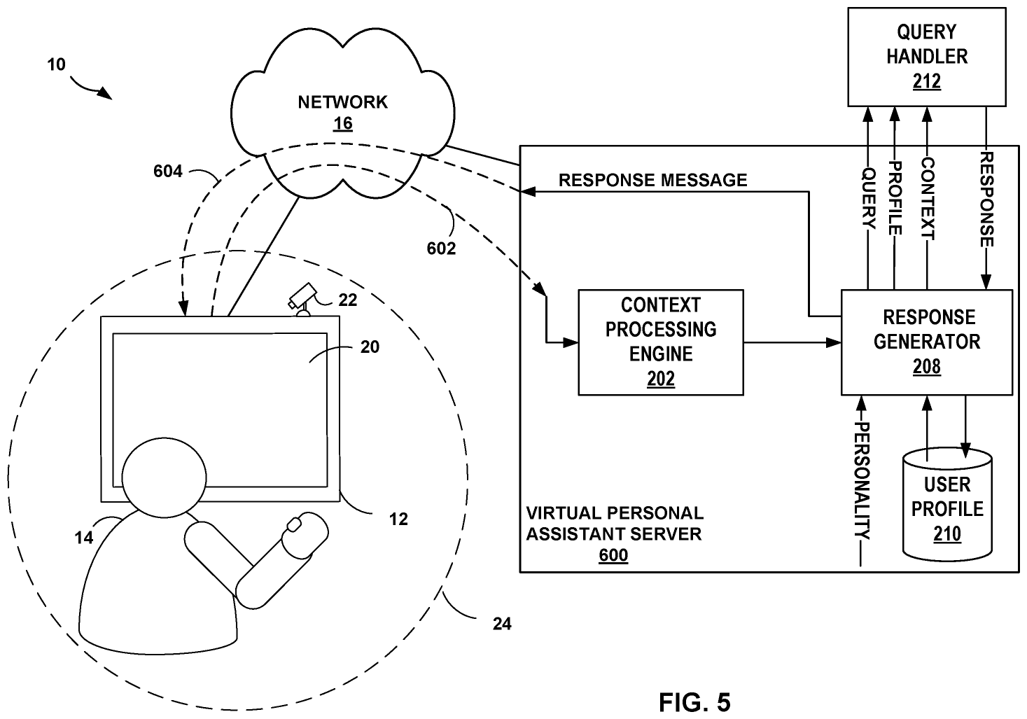

FIG. 5 is an illustration depicting another example virtual personal assistant system 10, in accordance with the techniques of the disclosure. In the example approach of FIG. 5, virtual personal assistant system 10 includes a personal assistant electronic device 12 that responds to queries from a user 14. Personal assistant electronic device 12 of FIG. 5 is shown for purposes of example and may represent any personal assistant electronic device, such as a mobile computing device, smartphone, smart speaker, laptop, tablet, laptop, desktop, artificial reality system, wearable or dedicated conferencing equipment. In the example shown in FIG. 5, personal assistant electronic device 12 includes a display 20 and a multimedia capture system 22 with voice and image capture capabilities.

As shown in FIG. 5, personal assistant electronic device 12 is connected to a query virtual personal assistant server 600 over a network 16. A user 14 submits a query to personal assistant electronic device 12. Personal assistant electronic device 12 captures input data representing the query and forwards the input data as a request 602 to virtual personal assistant server 600 over network 16, such as a private network or the Internet.

In one example approach, personal assistant electronic device 12 includes functionality to receive queries and context for the queries from one or more users 14. In one example approach, personal assistant electronic device 12 receives input data from a user 14. The input data includes one or more of audio data and video data from multimedia capture system 22. Personal assistant electronic device 12 forwards the input data with any context information it has determined around the query to context processing engine 202. In some examples, personal assistant electronic device 12 includes facial recognition software used to identify the source of the query. User identity then becomes part of the context information forwarded to context processing engine 202. In other example approaches, user identity is determined by logging into virtual personal assistant system 10, by accessing virtual personal assistant system 10 via an authenticated device, through voice recognition, via a badge or tag, by shape or clothing, or other such identification techniques.

In one example approach, virtual personal assistant server 600 includes a context processing engine 202, a response generator 208 and a query handler 212. In some example approaches, context processing engine 202 includes an environmental context engine 204 and a personal context engine 206, such as shown in FIG. 2.

In the example of FIG. 5, context processing engine 202 receives the input data and context information from personal assistant electronic device 12 and extracts additional context information from the input data before passing the input data, the context information received from personal assistant electronic device 12 and the context information captured by context processing engine 202 to response generator 208. In one example, response generator 208 receives the input data and the context information detailing the context of the query from context processing engine 202, extracts the query from the input data, and generates a message 604 to user 14 based on the query and the context of the query. In one such example approach, response generator 208 receives the input data and the context of the query from context processing engine 202, extracts the query from the input data, and generates a message 604 to user 14 based on the query, the context of the query and characteristics (such as emotion) of a personality assigned to the personal assistant of virtual personal assistant system 10. In one such example, personality characteristics are stored in a personal assistant profile data store.

As noted above in the discussion of FIG. 2, in one example approach, context is divided into two categories: environmental context and personal context. In one such example approach, context processing engine 202 includes an environmental context engine 204 and a personal context engine 206 as shown in FIG. 2. In some examples, each context system 204, 206 uses artificial intelligence to develop models for determining the relevant context. The environmental context identifying models are store in environmental context model stores, while the personal context identifying models are stored in personal context model stores.

In one example, response generator 208 receives the input data and the context information detailing the context of the query from context processing engine 202, extracts the query from the input data using speech recognition software, forwards the query to query handler 212, receives a response back from query handler 212 and generates a message for user 14 based on the context of the query. In one such example approach, response generator 208 receives the input data and the context of the query from context processing engine 202, extracts the query from the input data, forwards the query to query handler 212, receives a response back from query handler 212 and generates a message for user 14 based on the context of the query and characteristics (such as emotion) of a personality assigned to the personal assistant of virtual personal assistant system 10. In some example approaches, response generator 208 constructs a response message for user 14 based on the response from query handler 212, the context of the query and one or more personality characteristics selected for virtual personal assistant system 10 and stored in a personal assistant profile.

In one example approach, response generator 208 includes a speech recognition engine (such as speech recognition engine 328), a natural language generator (such as natural language generator 329) and a text-to-speech generator (such as text-to-speech generator 330). In one example approach, the speech recognition engine receives the input data from context processing engine 202 and determines the query from the input data. In one example approach, response generator 208 generates the message for user 14 using natural language generator 329, conditioned on one or more of the personality of virtual personal assistant system 10, environmental cues and personal cues such as the tone of the query and the tempo of the query. In one such example approach, response generator 208 generates text-to-speech via text-to-speech generator 330 to provide a desired tone or tempo, conditioned on one or more of the emotional characteristics of the personal assistant, the tone of the query and the tempo of the query.

In some examples, response generator 208 also maintains in user profile store 210 information on how to modify a response to a query as a function of a user identity. In some such examples, response generator 208 maintains in user profile store 210 information on how to modify a response to a query as a function of a characteristic of a user. For instance, user profile store 210 may include system preferences for replying to queries from children, or from the elderly, or from people dressed like medical professionals.

Query handler 212 receives the query and context information from response generator 208 and replies with a response to the query based on the query and the context information. For instance, the context information may indicate that the user would prefer a terse reply, so the response sent to response generator 208 is terse. In some example approaches, query handler 212 has the permissions necessary to access calendars and social media. In some such example approaches, query handler accesses one or more of a user's calendar and social media to obtain information on where the user will be in the future and uses that information to inform the response to the query.

In some examples, query handler 212 receives query, user profile information and context information from response generator 208 and replies with a response to the query based on the query, user profile information and the context information. For instance, even though the context information does not include any indicia that would lead to a terse message, the user profile information may indicate that the user would prefer a terse reply, so the response sent to response generator 208 is terse.

In one example, context processing engine 202 trains the environmental context identification models stored in an environmental context models store to recognize environmental cues using context information from previous queries. Context processing engine 202 also trains the personal context identification models stored in a personal context models store to recognize personal cues using context information from previous queries. In some example approaches, each environmental context identification model identifies one or more environmental cues and each personal context identification models identifies one or more personal cues.

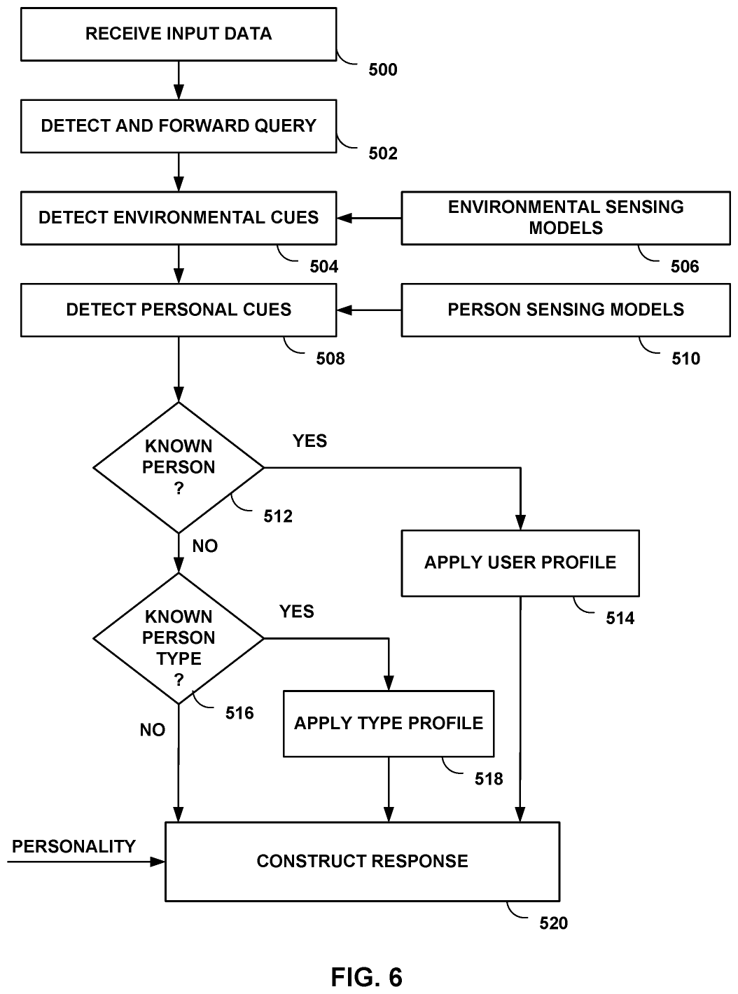

FIG. 6 is a flowchart illustrating example operation of virtual personal assistant system 10 of FIGS. 1-3 and 5, in accordance with the techniques of the disclosure. In the example shown in FIG. 6, virtual personal assistant system 10 receives one or more of audio data and image data as input data (500), which may comprise one or more of an audio track, a single image or a video stream captured by multimedia capture device 22.

Personal assistant electronic device 12 processes the input data to determine if a query has been received and, if a query has been received, the input data associated with the query is sent with any additional context information to context processing engine 202 (502). In one example approach, personal assistant electronic device 12 continuously monitors an audio track received from multimedia capture system 22 until a trigger word is detected and then extracts the query from the audio and image information received after the trigger word.

Context processing engine 202 receives the input data and any other context information developed by personal assistant electronic device 12 (such as user identity) and applies environmental cue sensing models 506 to the context information to detect one or more environmental cues (504). Context processing engine 202 then applies personal cue sensing models 510 to the context information to detect one or more personal cues (508).

Response generator 208 receives the input data and the context information detailing the context of the query from context processing engine 202, extracts the query and determines if the query is from a person with a profile in user profile store 210 (512). If so (YES branch of 512), response generator 208 applies the user profile of the user to the query (514). In one example approach, the user profile includes a response profile specifying one or more preferences for the user, each of the one or more preferences being associated with a manner in which response generator 208 responds to requests from the user. In one such example approach, the one or more preferences are set by response generator 208 in response to feedback from the user 14 to previous response messages. For instance, response generator 323 may be configured to generates a message for user 14 that matches the tone, tempo or emotion of user 14 when appropriate or that uses a tone, tempo or emotion other than the user's when appropriate. A user 14 may decide that the tone, tempo and emotion should always mirror the user, and set the preference in their response profile accordingly.

In one example approach, one or more parameters from the user's profile are forwarded to query handler 212 and are used with the query and the context information to determine a response. Query handler 212 then returns the response to response generator 208. Response generator 323 then generates a message for user 14 based on the response and the response profile (520).

If the query is not from a person with a profile in user profile store 210 (NO branch of 512), response generator 208 determines if the query is from a type of person with a profile in user profile store 210 (516). If so (YES branch of 516), response generator 208 applies a user type profile associated with the type of person to the query (518). In one example approach, the user type profile includes a response profile specifying one or more preferences for the type of user, each of the one or more preferences being associated with a manner in which response generator 208 is to respond to requests from that type of user. This approach can be used to provide special treatment to populations that would benefit from such typing. For instance, a user profile associated with children may be used to generate a response geared to children (e.g., appropriate for age or development level) and presented in a manner appropriate for children (e.g., presented with the voice of a cartoon character). In one such example, a question such as “How is the weather outside?” might be answered with “It's cold outside today, take a sweater to school.” instead of the longer, more nuanced answer provided to an adult.

In one example approach, one or more parameters from the user type profile are forwarded to query handler 212 and are used with the query and the context information to determine a response. Query handler 212 then returns the response to response generator 208. Response generator 323 then generates a message for user 14 based on the response and the user type profile.

If the query is not from a person with a profile in user profile store 210 and is not from a type of person with the user type profile in user profile store 210, response generator 208 creates a user profile for the user and applies a default user profile to the query (520). In one example approach, the default user profile includes a response profile specifying one or more preferences to be used for the default user, each of the one or more preferences being associated with a manner in which response generator 208 is to respond to requests from that type of user.

In one example approach, one or more parameters from the user's profile are forwarded to query handler 212 and are used with the query and the context information to determine a response. Query handler 212 then returns the response to response generator 208. Response generator 323 then generates a message for user 14 based on the response and the default profile.

In some example approaches, response generator 208 generates a message for user 14 based on the response, on the context of the query and on characteristics (such as emotion) of a personality assigned to the personal assistant of virtual personal assistant system 10. In some example approaches, one or more personality characteristics selected for virtual personal assistant system 10 are stored in a personal assistant profile and used to apply a personality to virtual personal assistant system 10. In other example approaches, one or more personality characteristics (such as voice and personality characteristics such as emotion) selected for virtual personal assistant system 10 are user selectable, are stored in their user profile and are used to apply a personality to virtual personal assistant system 10.

The techniques described in this disclosure may be implemented, at least in part, in hardware, software, firmware or any combination thereof. For example, various aspects of the described techniques may be implemented within one or more processors, including one or more microprocessors, DSPs, application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

As described by way of various examples herein, the techniques of the disclosure may include or be implemented in conjunction with a video communications system. The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A system comprising:
a personal assistant electronic device that receives input data indicative of a query specifying a request from a user within an environment;
a context processing engine configured to establish a context for the query, the engine applying trained models to the input data to identify personal and environmental cues associated with the query; and
a response generator configured to output a response message based on the request, the query context and a response profile for the user, the response profile specifying one or more preferences for the user, each of the one or more preferences being associated with a manner in which the response generator responds to requests from the user, each of the one or more preferences being set by the response generator in response to feedback from the user to previous response messages.

2. The system of claim 1, wherein the context processing engine and the response generator execute on a processor of the personal assistant electronic device.

3. The system of claim 1, wherein the context processing engine and the response generator execute on a processor external to the personal assistant electronic device.

4. The system of claim 1, wherein the at least one input source of the personal assistant electronic device comprises a microphone and the input data indicative of the query comprises audio data.

5. The system of claim 4, wherein the at least one input source of the personal assistant electronic device further comprises a camera and the input data further comprises image data captured coincident with the audio data.

6. The system of claim 1, wherein the context processing engine is configured to apply the one or more trained models to the input data to determine environmental cues based on any of: (i) noise level, (ii) presence of people within close proximity to the user, (iii) whether the user is in the presence of one or more of a set of predefined users, (iv) location, (v) location acoustics, (vi) degree of privacy, and (vii) time of day.

7. The system of claim 1, wherein the context processing engine is configured to apply the one or more trained models to the input data to determine personal cues based on any of a user parameter, an emotion, a speech pattern of the user, pitch, cadence, tone of voice and stridency.

8. The system of claim 7, wherein the input data includes information received from social media, wherein the context processing engine determines one or more personal cues from the information received from social media.

9. The system of claim 1, further comprising a query handler connected to the response generator, the query handler configured to:
receive, from the response generator, the request and context information relevant to the request, the context information based on the query context; and
transmit, to the response generator, a response based on the request and the context information relevant to the request.

10. The system of claim 1, further comprising a query handler connected to the response generator, the query handler configured to:
receive, from the response generator, the request and context information relevant to the request, the context information based on the query context and the user preferences; and
transmit, to the response generator, a response based on the request and the context information relevant to the request.

11. The system of claim 1, wherein the response generator includes a personality mode and a query handler, the query handler configured to:
receive the request and context information relevant to the request, the context information based on the query context and the personality mode; and
generate a response based on the request and the context information relevant to the request.

12. The system of claim 1, wherein the response generator includes a language processing engine configured to convey the response message as audio.

13. The system of claim 1, wherein the response generator includes a speech recognition engine, wherein the speech recognition engine extracts the request from an audio recording.

14. A method comprising:
receiving, by a personal assistant electronic device, input data indicative of a query specifying a request from a user within an environment;
determining, on a processor, a context for the query, wherein determining includes applying trained models to the input data to identify personal and environmental cues associated with the query; and
transmitting a response message to the user based on the request, the response message constructed based on the query context and on a response profile for the user, the response profile specifying one or more preferences for the user, each of the one or more preferences being associated with a manner in which the response generator responds to requests from the user, each of the one or more preferences being set by the response generator in response to feedback from the user to previous response messages.

15. The method of claim 14, wherein determining the context for the query includes obtaining one or more personal cues from social media.

16. The method of claim 14, wherein determining the context for the query includes obtaining personal cues from one or more of images and audio.

17. The method of claim 14, wherein the personal cues include one or more of user identifiers, user parameters, tone of voice, pitch, cadence and emotion.

18. The method of claim 14, wherein the environmental cues include one or more of location, noise level, size of group, and location acoustics.

19. The method of claim 14, wherein obtaining a response to the query includes accessing one or more of a calendaring application and a weather application.

20. A computer-readable storage medium comprising instructions that, when executed, configure one or more processors to:
receive input data indicative of a query specifying a request from a user within an environment;
determine, on a processor, a context for the query, wherein determining includes applying trained models to the input data to identify personal and environmental cues associated with the query; and
transmit a response message to the user based on the request, the response message constructed based on the query context and on a response profile for the user, the response profile specifying one or more preferences for the user, each of the one or more preferences being associated with a manner in which the response generator responds to requests from the user, each of the one or more preferences being set by the response generator in response to feedback from the user to previous response messages.
